(19) United States
(12) Patent Application Publication
(10) Pub. No.: US 2026/0008634 A1
(43) Pub. Date: Jan. 8, 2026

(54) Rail Connection and Conveying Device

(71) Applicant: Guizhou Power Grid Co., Ltd., Guiyang (CN)

(72) Inventors: Julong CHEN, Guiyang (CN); Yongqing ZHU, Guiyang (CN); Zhen LI, Guiyang (CN); Xueyong TANG, Guiyang (CN); Xuepeng MOU, Guiyang (CN); Yuxiang WANG, Guiyang (CN); Dameng LIU, Guiyang (CN); Bin WANG, Guiyang (CN); Chen LUO, Guiyang (CN); Yu ZHANG, Guiyang (CN); Qingsheng LI, Guiyang (CN); Jierui YANG, Guiyang (CN); Zhaofeng ZHANG, Guiyang (CN); Wei WANG, Guiyang (CN)

(21) Appl. No.: 19/007,981

(22) Filed: Jan. 2, 2025

Related U.S. Application Data
(63) Continuation of application No. PCT/CN2024/135946, filed on Nov. 29, 2024.

(30) Foreign Application Priority Data
Jul. 8, 2024 (CN) 2024109071792

(51) Int. Cl. B65G 47/53; B65G 17/30

(52) U.S. Cl. CPC B65G 47/53; B65G 17/30

(57) ABSTRACT

The present invention discloses a rail connection and conveying device, and relates to the technical field of slope rail type gravity energy accumulation, including a connection part, including a lifting piece and a rotating piece; a receiving part, mounted on the connection part and including a receiving shell, conveying belts and a frame, and a force-accumulating part, including a force-accumulating piece, a ratchet wheel and ratchet piece, an input bevel gear, and two output bevel gears. The present invention ensures that no matter the transport trolley enters from any side, the transport trolley can transfer kinetic energy and convert the kinetic energy into potential energy of a force-accumulating piece.

### CROSS-REFERENCE TO RELATED APPLICATIONS

The present application claims priority to Chinese Patent Application No. 2024109071792, filed on Jul. 8, 2024, the entire disclosure of which is incorporated herein by reference.

### TECHNICAL FIELD

The present invention relates to the technical field of slope rail type gravity energy accumulation, and in particular to a rail connection and conveying device.

### BACKGROUND

A slope rail type gravity energy accumulation technology uses a geographical height difference to be converted into gravitational potential energy, achieves conversion between mechanical energy and electric energy through an electric generator and an electromotor, and is an innovative physical energy storage solution, A system architecture includes three main parts: an upper stack, a slope rail and a lower stack, and three key subsystems integrated therein: a heavy block transport system, a connection and sorting system and a loading, unloading and stacking system. In view of the challenge of a complex mountain environment and a limited construction space, the heavy block transport system breaks through the traditional design, adopts a separated power scheme and creatively uses a chain transmission technology. Chain transmission has the characteristics of compact structure, high transmission efficiency, high adaptability and the like. A rail trolley is pulled through a chain to stably and efficiently complete a heavy-load and low-speed transfer task in a narrow space. The connection and sorting system integrates a multi-dimensional movement mechanism, and includes slope and horizontal rail connection, chain transmission and trolley lifting and traversing functions, thereby ensuring that an energy storage heavy block can be switched between different levels and positions accurately and rapidly. The loading, unloading and stacking system achieves efficient and safe loading and unloading and ordered stacking of heaving blocks by relying on automatic crane equipment and a steady maintenance-free steel frame structure. In general, by means of the chain transmission technology innovation and intelligent connection, loading, unloading and sorting design, the slope rail type gravity energy storage system greatly improves the energy storage efficiency and the environmental adaptability, particularly showing a technical leadership and practicability in complex terrain and limited space application scenarios.

In a current slope rail type gravity energy storage system, there are obvious problems in trolley connection between horizontal rails. Although each rail adopts chain transmission to independently drive the trolley, the power of the trolley is interrupted during connection switching between the rails, and it is necessary to provide extra power at the connected rail to help the trolley drive out. In existing design, the movement inertia of the trolley is not used, and a new power unit is required for each rail switching, resulting in increased operation cost and reduced energy utilization efficiency. Therefore, it is urgent to develop a new connection technology, use the inertia of the trolley and reduce the dependence on external power, thereby improving the system efficiency and economy.

### SUMMARY

In view of the problems in an existing rail connection and conveying device, the present invention is proposed.

Therefore, an objective of the present invention is to provide a rail connection and conveying device, which uses the inertia of the trolley and reduces the dependence on external power, thereby improving the system efficiency and economy.

To solve the above technical problems, the present invention provides the following technical solution: a rail connection and conveying device includes: a connection part, including a frame body, a lifting piece mounted on the frame body and a rotating piece mounted at an upper end of the lifting piece;
a receiving part, mounted on the connection part and including a bearing shell mounted on the rotating piece, two groups of symmetrical conveying belts for bearing a transport trolley being arranged inside the bearing shell, a frame being further rotatably arranged inside the receiving shell, and the frame being used to drive lower half portions of the conveying belts to uplift through a connecting rod; and
a force-accumulating part, mounted in the receiving part and including a force-accumulating piece mounted in the receiving shell, a ratchet wheel and ratchet piece for controlling unidirectional force accumulation of the force-accumulating piece being arranged on the force-accumulating piece, an input bevel gear being arranged above the ratchet wheel and ratchet piece, two output bevel gears being symmetrically arranged above the input bevel gear, and the output bevel gears being engaged with lifting portions of the conveying belts through a rotating rod and a second gear.

As a preferred solution of the rail connection and conveying device according to the present invention, a groove is formed at the center of the receiving shell, the force-accumulating piece is set as a clockwork spring and clamped in the groove, a ratchet wheel of the ratchet wheel and ratchet piece is inserted into the center of the force-accumulating piece through a clamping block at the center of a bottom surface, and a ratchet is arranged on a side surface of the ratchet wheel.

As a preferred solution of the rail connection and conveying device according to the present invention, the ratchet is arranged on the receiving shell, a magnetic block is arranged on a side of the ratchet, and an electromagnet for pulling the ratchet to be separated from the ratchet wheel is further arranged on the receiving shell.

As a preferred solution of the rail connection and conveying device according to the present invention, the input bevel gear is fixedly connected above the ratchet wheel, the input bevel gear is fixedly connected to the receiving shell through a bearing and a bracket, the two output bevel gears are respectively a first output bevel gear and a second output bevel gear, the first output bevel gear is in transmission connection with one conveying belt, the second output bevel gear is in transmission connection with the other conveying belt, and the first output bevel gear and the second output bevel gear are symmetrically arranged on the input bevel gear.

As a preferred solution of the rail connection and conveying device according to the present invention, two groups of supporting legs are symmetrically arranged on the receiving shell, one group of supporting legs corresponds to one conveying belt, each group is provided with three supporting legs, two of the supporting legs are located at two ends of the conveying belt and used for first gears at two ends of the conveying belt to mount, a toothed belt is arranged between the two first gears, a supporting plate is arranged at an upper position in the toothed belt, and the remaining supporting leg of the same group is arranged at the midpoint of the conveying belt.

As a preferred solution of the rail connection and conveying device according to the present invention, the rotating rod of the output bevel gears is rotatably arranged on the supporting leg located at the midpoint, a second rotating shaft of the frame is arranged on the supporting leg, and a torsional spring for the frame to restore balance is arranged on the second rotating shaft.

As a preferred solution of the rail connection and conveying device according to the present invention, the connecting rod is arranged on an outer wall of the second rotating shaft, a rotating cylinder is arranged at a lower end of the connecting rod, the rotating cylinder is located on a lower surface of the toothed belt of the conveying belt, and the second gear engaged with the toothed belt is arranged on the rotating rod.

As a preferred solution of the rail connection and conveying device according to the present invention, the frame is set as a rectangle and located outside the two groups of conveying belts, and a front end and a rear end of the frame are respectively close to front sides and rear sides of the conveying belts.

As a preferred solution of the rail connection and conveying device according to the present invention, the lifting piece includes a plate material mounted on the frame body, a hydraulic cylinder mounted below the plate material, a guide rod mounted inside the frame body and a moving plate moving up and down along the guide plate, an output shaft of the hydraulic cylinder being mounted below the moving plate.

As a preferred solution of the rail connection and conveying device according to the present invention, the rotating piece includes a motor mounted below the moving plate, the receiving shell is rotatably arranged above the moving plate, a through hole is formed at the center of the moving plate, and an output shaft of the motor passes through the moving plate to be fixed with the receiving shell.

The present invention has the following beneficial effects: according to the present application, two symmetrically distributed output bevel gears are provided and respectively engaged with two conveying belts accurately, thereby ensuring that no matter the transport trolley enters from the left side or right side of the receiving shell, the kinetic energy can be smoothly and effectively transmitted through the toothed belt, and the kinetic energy is converted into the potential energy of the force-accumulating piece. The force-accumulating piece achieves unidirectional energy accumulation through a ratchet wheel and ratchet structure, and only releases accumulated energy reversely through an unlocking mechanism when necessary, thereby ensuring the continuous and efficiency operation of the system, significantly improving the energy utilization efficiency and reducing the unnecessary pause time. In addition, according to the structural design of the connecting rod, the rotating cylinder and the frame of the present application, the engagement state of the toothed belt and the second gear can be adjusted in real time according to the actual entering direction and position of the transport trolley, thereby ensuring that no matter from which side the trolley enters, the force-accumulating piece can be driven properly to accumulate energy; and in addition to auxiliary connection, the rotating frame also has the ability of intercepting and stopping the moving trolley and gives strong self-adaptive connection performance to the device, thereby ensuring that seamless connection and efficient power transmission of the transport trolley between the rails can be completed stably and flexibly under various working conditions, and achieving efficient recovery and energy accumulation of the kinetic energy.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art may further obtain other drawings based on these accompanying drawings without inventive effort.

FIG. 1 is an overall structural schematic diagram of a rail connection and conveying device according to the present invention;

FIG. 2 is a structural schematic diagram of a top-view working state of a rail connection and conveying device according to the present invention;

FIG. 3 is a structural schematic diagram of a three-dimensional working state of a rail connection and conveying device according to the present invention;

FIG. 4 is a side-view structural schematic diagram of a rail connection and conveying device according to the present invention;

FIG. 5 is a structural schematic diagram of a receiving part and a force-accumulating part of a rail connection and conveying device according to the present invention;

FIG. 6 is a structural schematic diagram of a conveying belt part of a rail connection and conveying device according to the present invention;

FIG. 7 is an enlarged schematic diagram of a structure at a position A in FIG. 6;

FIG. 8 is a schematic diagram of a sectional structure in FIG. 5; and

FIG. 9 is an enlarged schematic diagram of a structure at a position B in FIG. 8.

### DETAILED DESCRIPTION OF THE EMBODIMENTS

To make the described objectives, features and advantages of the present invention more obvious and more understandable, the specific embodiments of the present invention are described in detail below in conjunction with the accompanying drawings.

A number of specific details are set forth in the description below to provide a thorough understanding for the present invention; however, the present invention may also be implemented in other manners different from those described herein, and those skilled in the art may make similar generalization without departing from the essence of the present invention; therefore, the present invention is not limited by the specific embodiments disclosed below.

Secondly, “one embodiment” or “embodiment” referred to herein refers to a specific feature, structure, or characteristic that may be included in at least one implementation manner of the present invention. The “in one embodiment” appearing in different parts of the present specification does not necessarily refer to the same embodiment, nor a separate or selective embodiment that is mutually exclusive to other embodiments.

Thirdly, the present invention is described in detail in conjunction with illustrations. When the embodiments of the present invention are described in detail, for ease of description, sectional views of the device structures are partially enlarged without being drawn to scale. The illustrations are merely exemplary and should not limit the protection scope of the present invention. Furthermore, the three-dimensional spatial dimensions of length, width and depth should be included in the actual production.

### Embodiment 1

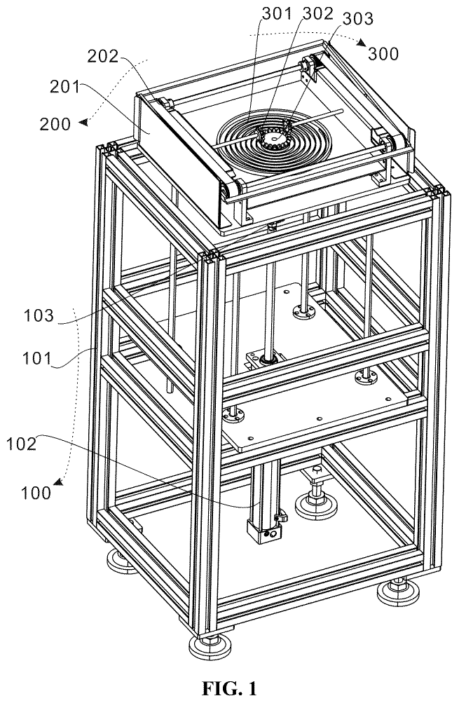

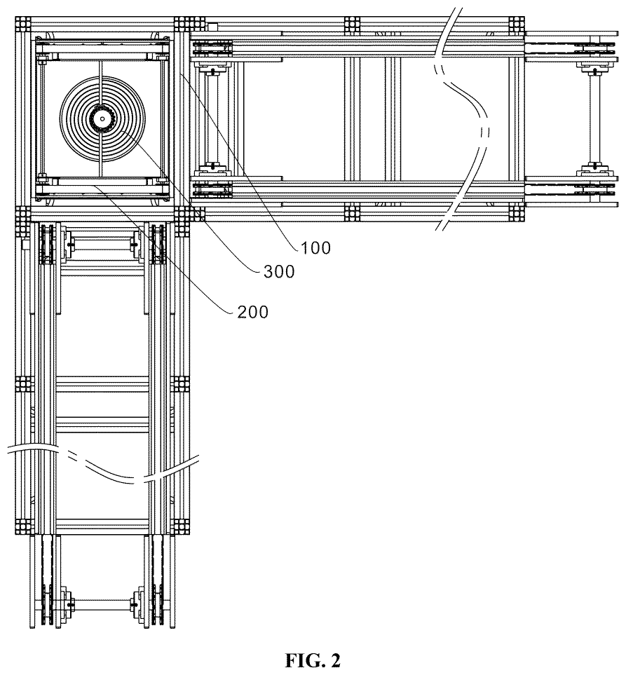

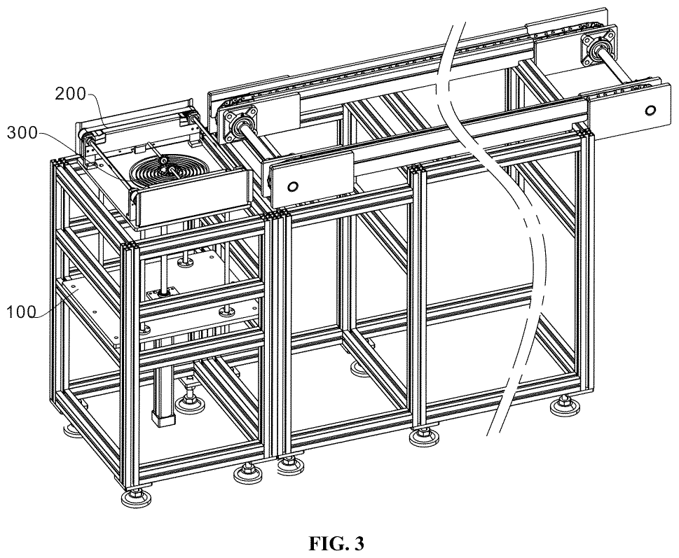

Referring to FIG. 1 to FIG. 5, which are a first embodiment of the present invention, a rail connection and conveying device is provided and includes: a connection part 100, including a frame body 101, a lifting piece 102 mounted on the frame body 101 and a rotating piece 103 mounted at an upper end of the lifting piece 102; a receiving part 200, mounted on the connection part 100 and including a bearing shell 201 mounted on the rotating piece 103, two groups of symmetrical conveying belts 202 for bearing a transport trolley being arranged inside the bearing shell 201, a frame 203 being further rotatably arranged inside the receiving shell 201, and a connecting rod 206 being arranged on a second rotating shaft 203a of the frame 203 to drive lower half portions of the conveying belts 202 to uplift; and a force-accumulating part 300, mounted in the receiving part 200 and including a force-accumulating piece 301 mounted in the receiving shell 201, a ratchet wheel and ratchet piece 302 for controlling unidirectional force accumulation of the force-accumulating piece being arranged on the force-accumulating piece 301, an input bevel gear 303 being arranged above the ratchet wheel and ratchet piece 302, two output bevel gears 304 being symmetrically arranged above the input bevel gear 303, and the output bevel gears 304 being engaged with the toothed belt 202b lifted by the conveying belts 202 through a rotating rod 305 and a second gear 306.

In this embodiment, the connection part 100 includes the frame body 101, the lifting piece 102 and the rotating piece 103, where the height is adjusted by the lifting piece 102; the rotating piece 103 ensures the flexible rotation of the connection part 100 at different angles; the two groups of conveying belts 202 are symmetrically arranged inside the rotatable receiving shell 201 on the receiving part 200 and are specially used to stabilize, bear and connect the transport trolley; the rotatable frame 203 is further arranged in the receiving shell 201; the connecting rod 206 and the rotating cylinder 205 are mounted on the second rotating shaft 203a and can drive the lower half portions of the conveying belts 202 to uplift when the transport trolley enters, thereby achieving trolley connection and power transmission; the ratchet wheel and ratchet piece 302 is arranged above the force-accumulating piece 301 in the force-accumulating part 300 and used to control unidirectional energy accumulation; the two output bevel gears 304 are symmetrically arranged above the ratchet wheel and ratchet piece 302; and the two output bevel gears 304 are engaged with the toothed belt 202b lifted by the conveying belts 202 respectively through the rotating rod 305 and the second gear 306. This means that no matter from which side of the receiving shell 201 the transport trolley enters, the power can be effectively transmitted to the corresponding output bevel gear 304 through the toothed belt 202b, and the kinetic energy of the trolley is converted into the potential energy of the force-accumulating piece 301. The ratchet wheel and ratchet piece 302 ensures that energy only can be accumulated unidirectionally, and the accumulated energy can be released reversely through an unlocking mechanism when necessary, thereby ensuring the continuous and efficient operation of the system, improving the energy utilization efficiency, reducing the pause time, guaranteeing the continuous operation performance of the system and achieving the functions of bidirectional power transmission and energy accumulation.

In addition, according to the structure of the connecting rod 206, the rotating cylinder 205 and the frame 203 of the present application, the engagement state of the toothed belt 202b and the second gear 306 can be adjusted in real time according to the entering direction and position of the transport trolley, thereby ensuring that no matter from which side of the rail the trolley enters, the force-accumulating piece 301 can be driven to accumulate energy. Meanwhile, the rotating frame 203 can adaptively intercept and stop the transport trolley in inertial motion in the connection process, showing strong adaptive connection ability. This intelligent and flexible design optimizes energy utilization and greatly improves the connection efficiency, so that the device can complete the connection and transfer of the transport trolley between the rails efficiently and stably under various complex working conditions.

### Embodiment 2

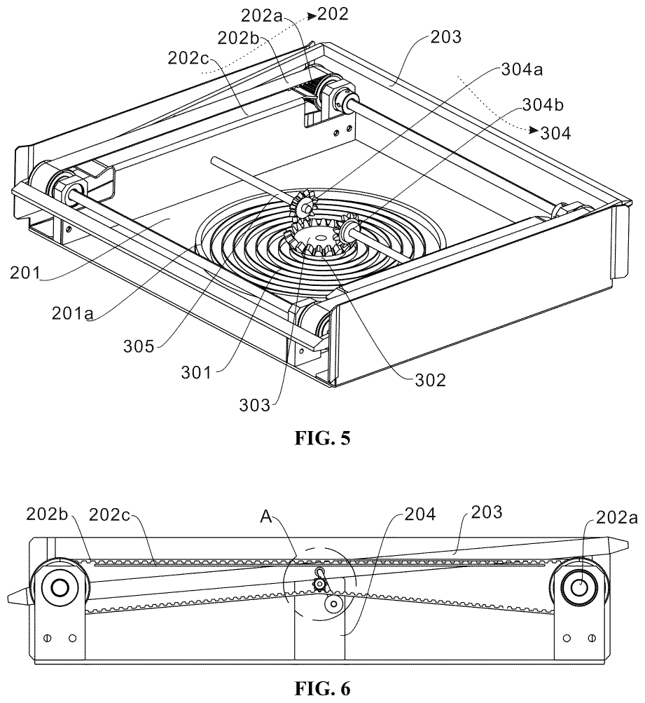

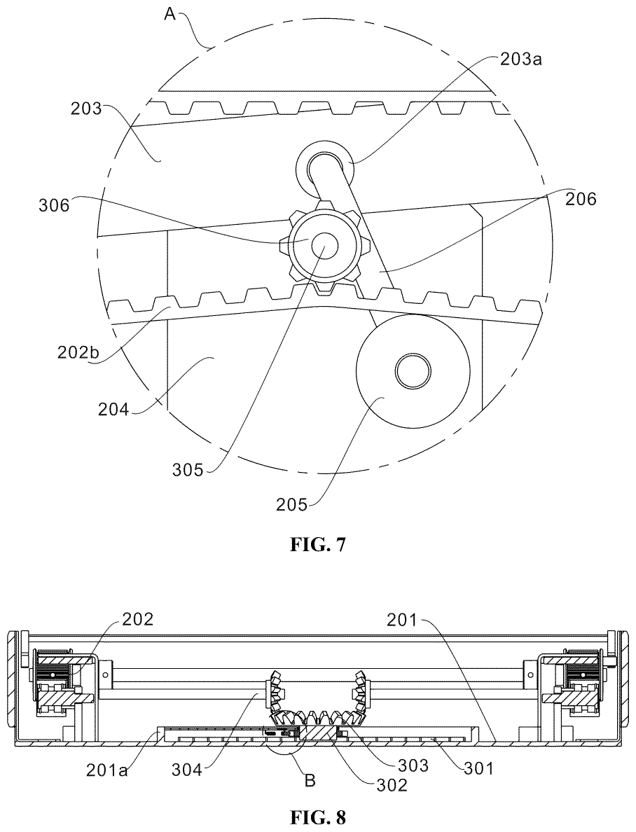

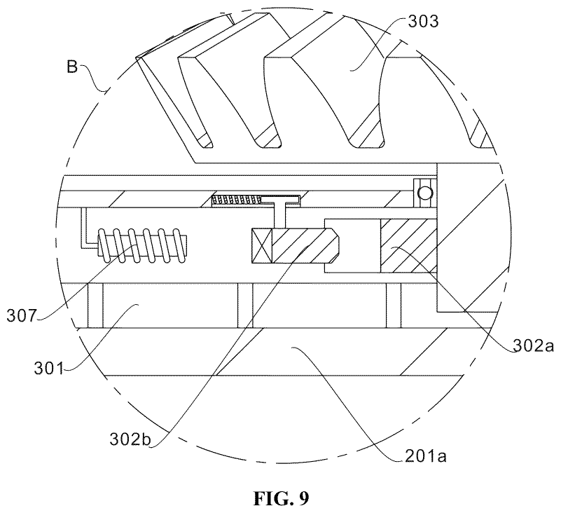

Referring to FIG. 5 to FIG. 9, which are a second embodiment of the present invention, this embodiment is different from the first embodiment in that: two groups of supporting legs 204 are symmetrically arranged on the receiving shell 201, one group of supporting legs 204 corresponds to one conveying belt 202, each group is provided with three supporting legs 204, two of the supporting legs 204 are located at two ends of the conveying belt 202 and used for first gears 202a at two ends of the conveying belt 202 to mount, a toothed belt 202b is arranged between the two first gears 202a, a supporting plate 202c is arranged at an upper position in the toothed belt 202b, and the remaining supporting leg 204 of the same group is arranged at the midpoint of the conveying belt 202. A rotating rod 305 of the output bevel gears 304 is rotatably arranged on the supporting leg 204 located at the midpoint, a second rotating shaft 203a of the frame 203 is located on the supporting leg 204, a torsional spring for the frame 203 to restore balance is arranged on the second rotating shaft 203a, a connecting rod 206 is arranged on the second rotating shaft 203a, a rotating cylinder 205 is arranged at a lower end of the connecting rod 206, the rotating cylinder 205 is located on a lower surface of the toothed belt 202b of the conveying belts 202, and a second gear 306 is arranged on the rotating rod 305 and engaged with the toothed belt 202b. An input bevel gear 303 is fixedly connected above the ratchet wheel 302a, the input bevel gear 303 is fixedly on the receiving shell 201 through a bearing and a bracket, the two output bevel gears 304 are respectively a first output bevel gear 304a and a second bevel gear 304b, the first output bevel gear 304a is engaged with one conveying belt 202, the second output bevel gear 304b is engaged with the other conveying belt 202, and the first output bevel gear 304a and the second output bevel gear 304b are symmetrically arranged on the input bevel gear 303.

The detailed use process of this section is: when the transport trolley enters from one side of the receiving shell 201, the weight of the transport trolley will press down on one side of the frame 203; the movement of the frame 203 can drive the toothed belt 202b on the left side to be engaged with the corresponding second gear 306 through the cooperation of the connecting rod 206 and the rotating cylinder 205; once the engagement is successful, the second gear 306 on the left side will start the first output bevel gear 304a to rotate forward under the transmission of the rotating rod 305, so that the first output bevel gear 304a drives the input bevel gear 303 to rotate; and the input bevel gear 303 and the ratchet wheel 302a are arranged coaxially, so that the force-accumulating piece 301 can accumulate and store energy, that is, the force accumulation process. When the force-accumulating piece 301 is required to release energy and push out the transport trolley reversely, the force-accumulating piece 301 reversely drives the input bevel gear 303 and the first output bevel gear 304a through the ratchet wheel 302a for reverse rotation, and the reversely rotated first output bevel gear 304a acts on the second gear 306 on the left side again through the rotating rod 305, so that the toothed belt 202b on the left side rotates reversely, and the transport trolley is pushed out in an opposite direction.

Similarly, when the transport trolley enters from the other side of the receiving shell 201, the same downward pressure acts on the other side of the frame 203, the connecting rod 206 and the rotating cylinder 205 cooperate with the rotating action of the frame 203, but this time is to drive the toothed belt 202b on the right side and the second gear 306 on the right side, the second gear 306 on the right side drives the second output bevel gear 304b under the transmission of the rotating rod 305 to rotate; then as in the previous process, the second output bevel gear 304b also drives the input bevel gear 303 to rotate, so that the force-accumulating piece 301 is driven by the ratchet wheel 302a to accumulate force; and in the release stage of the accumulated force, the force-accumulating piece 301 also reversely drives the input bevel gear 303 and the second output bevel gear 304b through the ratchet wheel 302a for reverse rotation, so that the second gear 306 on the right side and the toothed belt 202b on the right side are rotated reversely through the rotating rod 305, and the transport trolley can be pushed out reversely.

In conclusion, the design purpose of this system is that no matter from which side the transport trolley enters the receiving shell 201, power can be effectively transmitted through the corresponding transmission piece to the force-accumulating piece 301 for force accumulation or release, and the transport trolley is stably and efficiently transferred to a next rail from any side as required.

About how the system automatically selects an appropriate power transmission path according to the entering direction and position of the transport trolley, specifically, when the transport trolley enters and presses down on a certain side of the frame 203, the frame 203 will rotate due to the force, the rotation drives the connecting rod 206 through the second rotating shaft 203a to rotate, the connecting rod 206 drives the rotating cylinder 205 to uplift, and the toothed belt 202b on the corresponding side is driven to move upward, so that the toothed belt 202b is engaged with the second gear 306 on this side. At this time, the second gear 306 drives the first output bevel gear 304a or the second output bevel gear 304b mounted coaxially with the second gear by the rotating rod 305 to rotate. That is, if the transport trolley presses on a side of the frame 203 to cause the start of the transmission portion on the left side, the first output bevel gear 304a performs power transmission; otherwise, if the transmission portion on the right side is started, the second output bevel gear 304b undertakes the task of power transmission. In conclusion, the system can intelligently select the transmission portion corresponding to the first output bevel gear 304a or the transmission portion corresponding to the second output bevel gear 304b flexibly according to the actual position and entering direction of the transport trolley to perform power transmission, thereby achieving an efficient power distribution and transmission mechanism.

Further, when the transport trolley slides forward to a connection point on the previous horizontal rail by relying on a chain driving force or inertia of the previous horizontal rail, the own weight will be applied to one end of the frame 203, so that the frame 203 rotates like a lever. In this case, one end of the frame 203 sinks due to a downward pressure, and according to the lever principle, the other end of the frame 203 will be uplifted correspondingly to form an interception surface. When the transport trolley slides to an end point of the conveying belts 202, the upwarped frame 203, like a gate, can offset the residual kinetic energy of the transport trolley in time, thereby preventing the transport trolley from rushing out of a connection area due to excessive inertia, and ensuring that the transport trolley can stop at a predetermined position accurately and stably to complete effective connection between the rails. This design not only improves the safety of the system, but also ensures the fluency and stability of the whole connection process.

A groove 201a is formed at the center of the receiving shell 201, the force-accumulating piece 301 is set as a clockwork spring and clamped in the groove 201a, the ratchet wheel 302a of the ratchet wheel and ratchet piece 302 is inserted into the center of the force-accumulating piece 301 through a clamping block at the center of a bottom surface, and a ratchet 302b is arranged on a side surface of the ratchet wheel 302a. The ratchet 302b is arranged on the receiving shell 201, a magnetic block is arranged at an end of the ratchet, and an electromagnet 307 is arranged on the receiving shell 201 located on a side surface of the ratchet 302b.

It should be noted that the power-on and power-off of the electromagnet 307 is used to determine whether the ratchet wheel 302a keeps a locked state with the ratchet 302b. When the electromagnet 307 is powered off, the ratchet 302b will be engaged with the ratchet wheel 302a under the action of an internal reset spring to prevent the free reverse rotation of the ratchet wheel 302a, and at this time, the ratchet 302b is locked with the ratchet wheel 302a. In the movement process of the transport trolley, the inertia of the transport trolley will drive the toothed belt 202b to rotate so as to form a transmission chain sequentially through the output bevel gears 304, the input bevel gear 303 and the ratchet wheel 302a, so that the force-accumulating piece 301 can gradually accumulate and store energy in this process, that is, perform force accumulation.

On the contrary, when the electromagnet 307 is powered on and if an unlocking mode is set, the ratchet 302b is separated from the ratchet wheel 302a; when the force-accumulating piece 301 accumulates sufficient potential energy to be released, the ratchet wheel 302a is driven by the counter-acting force released by the force-accumulating piece 301 to start to rotate reversely, then the reversely rotated ratchet wheel 302a drives the input bevel gear 303 and the output bevel gears 304 for linkage, and finally the stored energy is converted into mechanical power through the toothed belt 202b, thereby urging the transport trolley to move along an opposite direction from the current position and pushing the transport trolley out of the receiving shell 201.

In this embodiment, the transport trolley is driven by the chain on the previous horizontal rail to move toward the receiving shell 201, a front end of the transport trolley is in contact with the frame 203 in a horizontal state under the action of the chain, and an outer side of the frame 203 is set as a trapezoidal shape, so that this end of the frame 203 is pressed downward; since the frame 203 is set in a lever form, the other end of the frame 203 is upwarped; the rotation of the frame 203 drives the fixedly connected second rotating shaft 203a to rotate, the second rotating shaft 203a rotates to drive the connecting rod 206 and the rotating cylinder 205 to offset, and the sleeve offsets to jack up a lower side of the toothed belt 202b of the conveying belts 202, so that the toothed belt 202b is engaged with the second gear 306; in this way, when the transport trolley drives the toothed belt 202b to rotate, the toothed belt 202b drives the second gear 306 to rotate, the second gear 306 drives the output bevel gears 304 fixedly connected thereto through the rotating rod 305 to rotate, the output bevel gears 304 drive the input bevel gear 303 to rotate, the input bevel gear 303 drives the ratchet wheel 302a to rotate, the ratchet wheel 302a drives the clockwork spring of the force-accumulating piece 301 to tighten and perform force accumulation until the transport trolley is completely moved to the receiving shell 201 under the action of the chain and the inertia and stops moving when being blocked by the upwarped end of the frame 203, and force accumulation is stopped.

When the receiving shell 201 corresponds to a next horizontal rail under the action of the lifting piece 102 and the rotating piece 103, the electromagnet 307 arranged on the side surface of the ratchet 302b is powered on to generate a magnetic force and is magnetically attracted to the magnetic block on the ratchet 302b, so that the ratchet 302b is removed from the ratchet wheel 302a; in this way, the clockwork spring will reversely drive the ratchet wheel 302a to rotate without the locking of the ratchet wheel and ratchet piece 302, the ratchet wheel 302a drives the input bevel gear 303 to rotate reversely, the input bevel gear 303 drives the two output bevel gears 304 to rotate, the output bevel gears 304 rotate to drive the second gear 306 to rotate, the second gear 306 drives the toothed belt 202b engaged with the second gear to rotate, and the rotation of the toothed belt 202b drives this conveying belt 202 to rotate, so that the transport trolley located on this conveying belt 202 is transported reversely and transferred to the next horizontal rail; then the electromagnet 307 is turned off, so that the ratchet 302b locks the ratchet wheel 302a again under the action of the internal reset spring, and the released force-accumulating piece 301 can perform force accumulation again; meanwhile, the frame 203 recovers the horizontal state again under the action of the internal torsional spring, which is ready for the next reception of the transport trolley.

In conclusion, the core of this section is to implement the accurate transfer and efficient power management of the transport trolley among different rails by using bidirectional transmission design and energy accumulation mechanism. When the transport trolley enters from any side of the receiving shell 201, the own gravity acts on the frame 203 and is converted on mechanism power when the toothed belt 202b is lifted through the designed mechanism of connecting rod 206 and rotating cylinder 205, thereby ensuring that no matter from the left side or the right side the transport trolley enters, the toothed belt 202b on the certain side will be correspondingly driven to be tightly engaged with the corresponding second gear 306; furthermore, once engagement is successful, the second gear 306 on the left side or right side drives the first output bevel gear 304a or the second output bevel gear 304b connected to the second gear through the rotating rod 305 to rotate forward, so that the input bevel gear 303 is driven to rotate; and the input bevel gear 303 and the ratchet wheel 302a are fixed, so that after being transmitted the toothed belt 202b and the output bevel gears 304, the kinetic energy of the transport trolley can be captured and converted into the potential energy in the force-accumulating piece 301, that is, the energy accumulation process is completed.

When the force-accumulating piece 301 is required to release the stored energy to transfer the transport trolley from the toothed belt 202b to the next rail, the force-accumulating piece 301 reversely drives the input bevel gear 303 and the corresponding output bevel gears 304 through the ratchet wheel 302a to rotate reversely. The reverse rotation process will cause the reverse rotation of the toothed belt 202b engaged therewith, so that the transport trolley is driven to move in an opposite direction, thereby ensuring that no matter from which side the trolley enters, the toothed belt 202b can rotate reversely through the clever symmetrical design to push the trolley out of the next rail smoothly and efficiently from any side. By combining the double-side transmission structure with the energy accumulation release mechanism, the device ensures that no matter from which side of the receiving shell 201 the transport trolley enters, the own kinetic energy can be utilized flexibly and efficient and energy can be released at an appropriate time, thereby implementing the free conversion of the trolley among different rails.

The remaining structure is the same as the structure in Embodiment 1.

### Embodiment 3

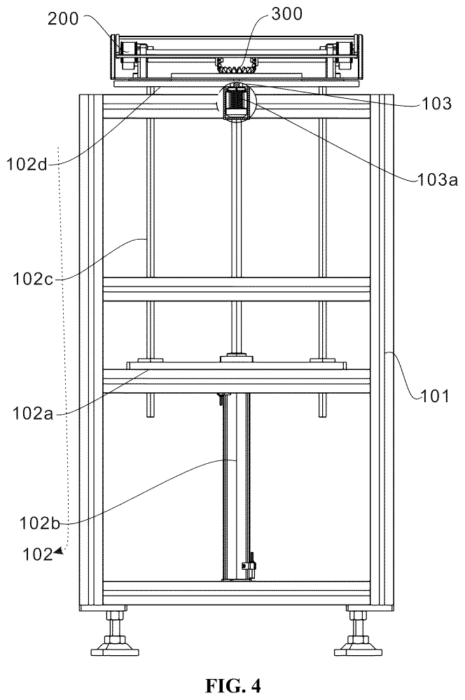

Referring to FIG. 1 and FIG. 4, which are a third embodiment of the present invention, this embodiment is different from the second embodiment in that: the lifting piece 102 includes a plate material 102a mounted on the frame body 101, a hydraulic cylinder 102b mounted below the plate material 102a, a guide rod 102c mounted inside the frame body 101 and a moving plate 102d moving up and down along the guide plate, where an output shaft of the hydraulic cylinder 102b is mounted below the moving plate 102d. The rotating piece 103 includes a motor 103a mounted below the moving plate 102d, the receiving shell 201 is rotatably arranged above the moving plate 102d, a through hole is formed at the center of the moving plate 102d, and an output shaft of the motor 103a passes through the moving plate 102d to be fixed with the receiving shell 201.

It should be noted that the receiving shell 201 is rotatably arranged above the moving plate 102d, that is, a plane bearing, a ball or other rotatable parts is arranged between a bottom surface of the receiving shell 201 and an upper surface of the moving plate 102d; in this way, the moving plate 102d directly bears the weights of the receiving shell 201 and the parts located on the receiving shell 201, so that the moor 103a arranged at the bottom of the moving plate 102d and fixed with the bottom surface of the receiving shell 201 through the output shaft can easily drive the receiving shell 201 to turn, and the transport trolley located inside the receiving shell 201 can be turned, thereby performing connection movement on the transport trolley among the horizontal rails in different directions. The hydraulic cylinder 102b and the moving plate 102d are used to drive the receiving part 200 and the transport trolley to ascend and descend for adjustment, thereby switching the transport trolley among the horizontal rails at different altitudes.

In this embodiment, when it is necessary to connect the two adjacent horizontal rails at different altitudes, the hydraulic cylinder 102b is started first to extend and retract to drive the moving plate 102d to ascend and descend correspondingly along a plurality of guide rods 102c, the moving plate 102d ascends and descends to drive the rotating piece 103 mounted thereon and the receiving part 200 to ascend and descend, so that the receiving part 200 is lifted to the end of the rail on which the transport trolley moves and is kept flush with the rail, the transport trolley is moved onto the receiving part 200 and locked, then the hydraulic cylinder 102b extends to the highest position, and the receiving part 200 is lifted above the frame body 101, so that the receiving part 200 will not be blocked by the surrounding frame body 101 during rotation; then the motor 103a is started to drive the receiving shell 201 of the receiving part 200 through the output shaft to rotate on the moving plate 102d, so that the transport trolley can directly move onto the next horizontal rail; then the hydraulic cylinder 102b controls the moving plate 102d to ascend and descend, so that the transport trolley is flush with the next horizontal rail; and then the bearing part pushes the transport trolley onto the next horizontal rail for transportation.

The remaining structure is the same as the structure in Embodiment 2.

Importantly, it should be noted that the constructions and arrangements of the present application shown in a plurality of different exemplary implementation solutions are merely exemplary. Although only a few implementation solutions are described in detail in the contents disclosed herein, those having reference to the contents disclosed herein should readily understand that many modifications are possible (for example, variations in the sizes, dimensions, structures, shapes and proportions of various elements, parameter values (such as temperatures and pressures), installations and arrangements, use of materials, colors, orientations, etc.), without materially departing from the novel teachings and advantages of the subject described in the present application. For example, the elements shown as integrally formed may be constructed of a plurality of parts or elements, the positions of the elements may be inverted or varied in other manners, and the properties, quantities or positions of the discrete elements may be altered or varied. Therefore, all such modifications are intended to be included within the scope of the present invention. The order or sequence of any process or method steps may be changed or re-sequenced according to alternative embodiments. In the claims, any provision of “apparatus with function” is intended to cover the structure described herein for executing the function, and is not merely structurally equivalent but also equivalent in structure. Other substitutions, modifications, variations, and omissions may be made in the design, operation conditions, and arrangements of the exemplary implementation solutions without departing from the scope of the present invention. Therefore, the present invention is not limited to the specific implementation solutions but extends to a plurality of modifications still falling within the scope of the appended claims.

In addition, for a concise description of the exemplary implementation solutions, all features of actual embodiments (that is, those that are not related to the currently considered best mode for carrying out the present invention, or those that are not related to the practice of the present invention) may not be described.

It should be noted that the above embodiments are merely used to describe, but not to limit, the technical solution of the present invention. Although the present invention is described in detail with reference to the preferred embodiments, those of ordinary skill in the art should understand that the technical solution of the present invention can be modified or equivalently replaced without departing from the spirit and scope of the technical solution of the present invention, and should be included in the scope of the claims of the present invention.

What is claimed is:

1. A rail connection and conveying device, comprising:
a connection part, comprising a frame body, a lifting piece mounted on the frame body and a rotating piece mounted at an upper end of the lifting piece;
a receiving part, mounted on the connection part and comprising a bearing shell mounted on the rotating piece, two groups of symmetrical conveying belts for bearing a transport trolley being arranged inside the bearing shell, a frame being further rotatably arranged inside the receiving shell, and the frame being used to drive lower half portions of the conveying belts to uplift through a connecting rod; and
a force-accumulating part, mounted in the receiving part and comprising a force-accumulating piece mounted in the receiving shell, a ratchet wheel and ratchet piece for controlling unidirectional force accumulation of the force-accumulating piece being arranged on the force-accumulating piece, an input bevel gear being arranged above the ratchet wheel and ratchet piece, two output bevel gears being symmetrically arranged above the input bevel gear, and the output bevel gears being engaged with lifting portions of the conveying belts through a rotating rod and a second gear.

2. The rail connection and conveying device according to claim 1, wherein a groove is formed at the center of the receiving shell, the force-accumulating piece is set as a clockwork spring and clamped in the groove, a ratchet wheel of the ratchet wheel and ratchet piece is inserted into the center of the force-accumulating piece through a clamping block at the center of a bottom surface, and a ratchet is arranged on a side surface of the ratchet wheel.

3. The rail connection and conveying device according to claim 2, wherein the ratchet is arranged on the receiving shell, a magnetic block is arranged on a side of the ratchet, and an electromagnet for pulling the ratchet to be separated from the ratchet wheel is further arranged on the receiving shell.

4. The rail connection and conveying device according to claim 3, wherein the input bevel gear is fixedly connected above the ratchet wheel, the input bevel gear is fixedly connected to the receiving shell through a bearing and a bracket, the two output bevel gears are respectively a first output bevel gear and a second output bevel gear, the first output bevel gear is in transmission connection with one conveying belt, the second output bevel gear is in transmission connection with the other conveying belt, and the first output bevel gear and the second output bevel gear are symmetrically arranged on the input bevel gear.

5. The rail connection and conveying device according to claim 2, wherein two groups of supporting legs are symmetrically arranged on the receiving shell, one group of supporting legs corresponds to one conveying belt, each group is provided with three supporting legs, two of the supporting legs are located at two ends of the conveying belt and used for first gears at two ends of the conveying belt to mount, a toothed belt is arranged between the two first gears, a supporting plate is arranged at an upper position in the toothed belt, and the remaining supporting leg of the same group is arranged at the midpoint of the conveying belt.

6. The rail connection and conveying device according to claim 5, wherein the rotating rod of the output bevel gears is rotatably arranged on the supporting leg located at the midpoint, a second rotating shaft of the frame is arranged on the supporting leg, and a torsional spring for the frame to restore balance is arranged on the second rotating shaft.

7. The rail connection and conveying device according to claim 6, wherein the connecting rod is arranged on an outer wall of the second rotating shaft, a rotating cylinder is arranged at a lower end of the connecting rod), the rotating cylinder is located on a lower surface of the toothed belt of the conveying belt, and the second gear engaged with the toothed belt is arranged on the rotating rod.

8. The rail connection and conveying device according to claim 7, wherein the frame is set as a rectangle and located outside the two groups of conveying belts, and a front end and a rear end of the frame are respectively close to front sides and rear sides of the conveying belts.

9. The rail connection and conveying device according to claim 1, wherein the lifting piece comprises a plate material mounted on the frame body, a hydraulic cylinder mounted below the plate material, a guide rod mounted inside the frame body and a moving plate moving up and down along the guide plate, an output shaft of the hydraulic cylinder being mounted below the moving plate.

10. The rail connection and conveying device according to claim 9, wherein the rotating piece comprises a motor mounted below the moving plate, the receiving shell is rotatably arranged above the moving plate, a through hole is formed at the center of the moving plate, and an output shaft of the motor passes through the moving plate to be fixed with the receiving shell.
